(19) United States
(12) Patent Application Publication
(10) Pub. No.: US 2009/0037176 A1
(43) Pub. Date: Feb. 5, 2009

(54) CONTROL AND CONFIGURATION OF A SPEECH RECOGNIZER BY WORDSPOTTING

(75) Inventor: Jon A. Arrowood, Smyrna, GA (US)

Correspondence Address: OCCHIUTI ROHLICEK & TSAO, LLP, 10 FAWCETT STREET, CAMBRIDGE, MA, 02138, US

(73) Assignee: Nexidia Inc., Atlanta, GA (US)

(21) Appl. No.: 12/184,445

(22) Filed: Aug. 1, 2008

Related U.S. Application Data
(60) Provisional application No. 60/953,511, filed on Aug. 2, 2007.

(51) Int. Cl. G10L 15/00

(52) U.S. Cl. 704/253; 704/E15.001

(57) ABSTRACT

A wordspotting system is applied to a speech source in a preliminary processing phase. The putative hits corresponding to queries (e.g., keywords, key phrases, or more complex queries that may include Boolean expressions and proximity operators) are used to control a speech recognizer. The control can include one or more of application of a time specification that is determined from the putative hits for selecting an interval of the speech source to which to apply the speech recognizer; application of a grammar specification determined from the putative hits that is used by the speech recognizer, and application of a specification of a lattice or pruning specification that is used by the recognizer to limit or guide the recognizer in recognition of the speech source.

### CROSS-REFERENCE TO RELATED APPLICATIONS

This application claims the benefit of U.S. Provisional Application No. 60/953,511, titled “CONTROL AND CONFIGURATION OF A SPEECH RECOGNIZER BY WORDSPOTTING,” filed Aug. 2, 2007. This application is incorporated herein by reference.

### BACKGROUND

This invention relates to control and/or configuration of a speech recognizer by wordspotting.

Automatic speech recognition that produces a transcription (also known as “speech-to-text” processing) of a speech input can be computationally expensive, for example, when the recognizer users a large vocabulary, detailed acoustic models, or a complex grammar that encodes semantic or syntactic constraints for an application.

On the other hand, a computationally efficient wordspotter is able to process a speech input rapidly, for some implementations being one or more orders of magnitude faster, than speech recognition. However, in some applications, it is desirable to obtain a type of result that might be provided by transcription-oriented speech recognizer.

An example of a wordspotter is produced by Nexidia, Inc., for example, as described in U.S. Pat. No. 7,263,484, titled “Phonetic Searching,” which is incorporated by reference. This wordspotter can achieve throughput rates that are generally not attainable by transcription-oriented speech recognizers using comparable computation resources. For example, real time monitoring of 100 speech streams in parallel for 100 terms is possible using modest hardware. Or in batch mode, a one hour file can be searched for 100 terms in less than 1/100th of an hour. On the other hand, full text-to-speech is much more resource intensive, typically running at or slower than real-time. For example, a speech recognizer of a type described in Lee, et al. “Speaker-Independent Phone Recognition Using Hidden Markov Models,” IEEE Trans. Acoustics Speech and Signal Proc., vol. 37(11) (1989), generally requires significantly greater computational resources to process a speech source.

### SUMMARY

In one aspect, in general, a wordspotting system is applied to a speech source in a first processing phase. Putative hits corresponding to queries (e.g., keywords, key phrases, or more complex queries that may include Boolean expressions and proximity operators) are used to control a speech recognizer. The control can include one or more of application of a time specification that is determined from the putative hits for selecting an interval of the speech source to which to apply the speech recognizer; application of a grammar specification determined from the putative hits that is used by the speech recognizer, and application of a specification of a lattice or pruning specification that is used by the recognizer to limit or guide the recognizer in transcription of the speech source.

Advantages can include one or more of the following.

Full automated speech recognition to transcribe large amounts of speech data may be computationally expensive, and unnecessary if transcriptions of all the speech data is not required. Using the output of a word spotter can reduce the amount of speech data that needs to be processed, thereby reducing the computational resources needed for such processing. As an example, only certain calls in a call center, or only particular parts of such calls, may be transcribed based on the putative hits located in those calls or parts or calls.

For some automated speech recognition systems, accuracy may be increased by configuration that is chosen for a particular speech source. For example, use of a language model (e.g., grammar), language selection, or speech processing or normalization parameters, that match a speech source can increase accuracy as opposed to use of general parameters that are suitable for a variety of types of speech sources.

Other features and advantages of the invention are apparent from the following description, and from the claims.

### DESCRIPTION OF DRAWINGS

FIG. 1 is a block diagram of a speech processing system.

### DESCRIPTION

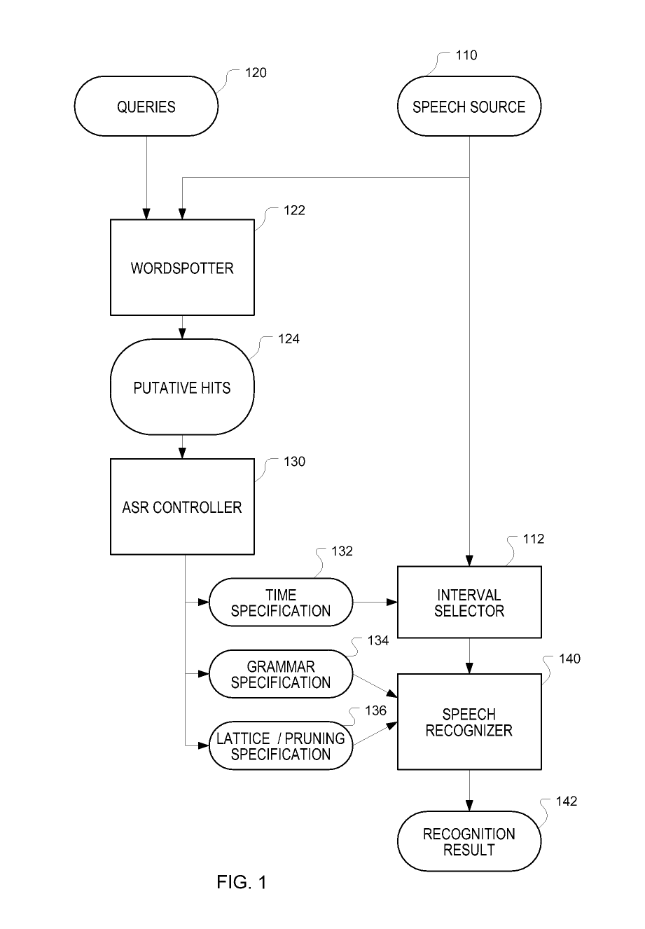

Referring to FIG. 1, a speech processing system includes both a wordspotter 122 and a transcription-oriented speech recognizer 140. In some examples, the wordspotter 122 uses techniques described in U.S. Pat. No. 7,263,484, titled “Phonetic Searching,” and the speech recognizer 140 uses techniques of the type described in Lee, et al. “Speaker-Independent Phone Recognition Using Hidden Markov Models.”

A speech source 110 provides a stream of voice communication to the system. As an example, the speech source is associated with one (or more) live telephone conversation, for example, between a customer and a telephone call center agent, and the speech processing system is used to compute full transcription of portions of one or more of such conversations.

In some examples a set of queries 120 are defined for searching occurrences (putative hits) in a speech source 110 by the wordspotter 122. As described further below, these queries are designed such that their corresponding putative hits produced by the wordspotter 122 in processing the speech source 110 will be useful to an ASR (automatic speech recognizer) controller 130 for controlling a speech recognizer 140 that also processes the speech source 110 (or selected portions of the source).

In different examples of the system, the ASR controller uses one or more ways to control the speech recognizer 140.

In some examples, wordspotting is used to control and configure the speech recognizer through locating interesting time intervals that should be further recognized. For some applications, presence of certain words is indicative that the corresponding part of the conversation should be further recognized. In one example, if an application requires detection and full transcription of all digit sequences, then a presence of a high density of digits may be used to determine a start and end time in the speech source to provide to an interval selector 112 that passes only the specified time interval to the speech recognizer 140. In this way, the relatively computationally expensive recognizer is applied only to the time intervals of the speech source that are most likely to contain transcriptions of interest.

In some examples, the putative hits produced by the wordspotter are used to determine a likely topic of conversation. For example, an application may require transcription of passages of a conversation related to billing disputes, and the putative hits are used to essentially perform a topic detection or identification/classification (e.g., from a closed set) prior to determining whether to recognize the source. The queries are selected, for example, to be words that are indicative of the topic of the conversation. The start and end times can for further recognition can then be determined according to the temporal range in which the relevant queries were detected, or may be extended, for example, to include an entire passage or speaker's turn in a conversation.

In some examples, wordspotting is used, in some examples in conjunction with the ways described above, in the selection of an appropriate grammar specification or vocabulary to provide to the speech recognizer. For example, the speech source may include material related to different topics, for example, billing inquiries versus technical support in a call center application, medical transcription versus legal transcription in a transcription application, etc. The queries may be chosen so that the resulting putative hits can be used for a topic detection or classification task. Based on the detected or classified topic, an appropriate grammar specification 134 is provided to the speech recognizer 140.

In some examples, the grammar specification relates to a relative shorter part of the speech source and is used in conjunction with a time specification that is also determined from the putative hits. For example, an application may require transcription of a parcel tracking number that has a particular syntax that may be encoded in a grammar (such as a finite state grammar). The putative hits can then be used to both detect the presence of the tracking number for selection of the appropriate time interval as well as specification of a corresponding grammar with which the speech recognizer may transcribe the selected speech.

In some examples, wordspotting is used to determine the language being spoken in the speech source. For example, queries are associated with multiple languages, for example, words from multiple languages, or words or subwords such that the presence of putative hits is informative as to the language (e.g., according to a statistical classifier). Once the language being spoken is determined, further wordspotting or automatic transcription is configured according to the identified language.

In some examples, wordspotting is used, in some examples in conjunctions with one or more of the foregoing approaches, in essentially a way of constraining the speech recognizer so that it can process the speech source more quickly. In some examples, the wordspotting putative hits are used to construct a word lattice that is used by the speech recognizer as a constraint on possible word sequences that may be recognizer. In some such examples, the lattice is augmented with certain words (e.g., short words) that are not included in the queries but that may be appropriate to include in the transcription output. In other examples, entire lattice generation step is replaced by using wordspotting to generate word candidate locations. These candidate locations are then used by the speech recognizer in its internal pruning procedures or word hypothesizing procedures (e.g., propagation to new words in a grammar).

In some examples, calls in a call center's archive that should be transcribed are identified according to a word spotting algorithm, rather than trying to transcribe all calls. For example, wordspotting could be used to find recordings related to when a customer is cancelling service. Then only these calls might be sent to a recognizer for transcription, and further analysis. Another potential use is to identify specific locations within a recording for recognition, such as finding where a number is spoken, and the using a high-powered natural-speech number recognition language model on this area.

In some examples, wordspotting is used to identify putative hits which are then used to determine signal processing or statistical normalization parameters for processing the speech source prior to application of the ASR engine or for modification of acoustic model parameters used by the ASR engine. For example, based on the time association of portions of the putative hits (e.g., the states of the query) and the acoustic signal (e.g., the processed form of the signal, such as a Cepstral representation) signal processing parameters are determined. In some examples, a spectral warping factor is determined to best match the warped spectrum to reference models used to specify the query. In some examples, normalization parameters corresponding to a spectral equalization (e.g., additive terms added to a Cepstral representation) are determined from the putative hits. In some examples, other parameters for the ASR engine are determined from the putative hits, such as pruning thresholds based on the scores of the putative hits.

In some examples, multiple different ASR systems are available to be applied to the automated transcription task. Wordspotting is then used to identify which ASR engine or language model to use if you had more than one available. For example, if a medical ASR system and a legal ASR system are available, wordspotting could be used to quickly classify recordings as being medical or legal, and the proper engine could be used. Another potential use is to use wordspotting to alter a language model. For example, a quick wordspotting pass may identify several legal terms in an audio stream or recording. This information could be used to alter the language model used for this particular stream or recording based on this information, by adding other related terms and/or altering word and phrase likelihoods to reflect the likely classification of the document.

In some examples, the same speech source is applied to the wordspotting procedure as is applied to the automated speech recognition procedure. In some examples, different data is used. For example, representative speech data is applied to the wordspotting procedure, for example, to determine a topic, language, or appropriate signal processing or normalization parameters, and different speech data that shares those characteristics is provided to the speech recognition procedure.

The forgoing approaches may be implemented in software, in hardware, or in a combination of the two. In some examples, a distributed architecture is used in which the wordspotting stage is performed at a different location of the architecture than the automated speech recognition. For example, the wordspotting may be performed in a module that is associated with a particular conversation or audio source, for example, associate with a telephone for a particular agent in a call center, while the automated speech recognition may be performed in a more centralized computing resource, which may have greater computational power. In examples in which some or all of the approach is implemented in software, instructions for controlling or data imparting functionality on a general or special purpose computer processor or other hardware is stored on a computer readable medium (e.g., a disk) or transferred as a propagating signal on a medium (e.g., a physical communication link).

It is to be understood that the foregoing description is intended to illustrate and not to limit the scope of the invention, which is defined by the scope of the appended claims. Other embodiments are within the scope of the following claims.

What is claimed is:

1. A method for processing a speech source comprising:
applying a wordspotting procedure to the speech source according to a set of specified queries to produce a set of putative hits corresponding to the queries;
computing a speech recognition specification from the produced putative hits; and
applying a speech recognition procedure to the speech source according the speech recognition specification to produce a transcription of at least some of the speech source.

2. The method of claim 1 wherein producing the putative hits includes producing match scores and time locations for the putative hits, and computing the speech recognition specification includes using at least some of the match scores.

3. The method of claim 1 wherein computing the speech recognition specification includes:
computing a grammar specification for configuring the speech recognition procedure.

4. The method of claim 3 wherein computing the grammar specification includes determining a topic in the speech source using the putative hits and determining the grammar specification according to the determined topic.

5. The method of claim 3 wherein computing the grammar specification includes detecting presence of a syntactic element, and determining a grammar specification according to the syntactic element.

6. The method of claim 5 wherein detecting presence of the syntactic element includes detecting presence of an identification number.

7. The method of claim 1 wherein computing the speech recognition specification includes:
computing a constraint specification for constraining possible transcription outputs of the speech recognition procedure.

8. The method of claim 7 wherein computing the constraint specification includes constructing a lattice for use by the speech recognition procedure.

9. The method of claim 7 wherein computing the constraint specification includes determining constraints on presence of words in a transcription vocabulary at times in the speech source, and wherein the speech recognition uses the constraints on the presence of words to limit processing of the speech source.

10. The method of claim 1 wherein computing the speech recognition specification includes:
determining parameters associated with acoustic processing and/or modeling for the speech recognition procedure.

11. The method of claim 1 wherein computing the speech recognition specification includes:
computing a time specification for selecting a time interval of the speech source for application of the speech recognition procedure.

12. The method of claim 11 wherein computing the time specification includes using time locations of one or more of the putative hits to determine a start and an end time for application of the speech recognition procedure.

13. The method of claim 1 wherein computing the speech recognition specification includes:
identifying a language spoken in the speech source.

14. A system for processing a speech source comprising:
a wordspotting component for processing the speech source according to a set of specified queries to produce a set of putative hits corresponding to the queries;
a control component for computing a speech recognition specifications from the produced putative hits; and
a speech recognizer for processing the speech source according the speech recognition specification to produce a transcription of at least some of the speech source.
